(19) United States
(12) Patent Application Publication
(10) Pub. No.: US 2015/0064536 A1
(43) Pub. Date: Mar. 5, 2015

(54) BATTERY WITH MULTIPLE ELECTRODE ENGAGING PORTIONS

(71) Applicant: SAMSUNG SDI CO., LTD., Yongin-si (KR)

(72) Inventors: Jeong-Seop LEE, Yongin-si (KR); Seok-Gyun CHANG, Yongin-si (KR); Eun-Joo KWAK, Yongin-si (KR); Myung-Sook KWON, Yongin-si (KR); Sung-Gyu SHIN, Yongin-si (KR)

(21) Appl. No.: 14/469,908

(22) Filed: Aug. 27, 2014

(30) Foreign Application Priority Data
Aug. 28, 2013 (KR) 10-2013-0102120

(51) Int. Cl. H01M 2/30; H01M 2/20

(52) U.S. Cl. CPC H01M 2/30; H01M 2/202; H01M 2220/30
USPC 429/121; 429/211

(57) ABSTRACT

A battery includes a first electrode terminal of a first shape, a second electrode terminal of a second shape, a third electrode terminal of a third shape, and a fourth electrode terminal of a fourth shape. The first and third electrode terminals have a first polarity, and the second and fourth electrode terminals have a second polarity opposite to the first polarity. The first shape is complementary to the second shape, and the third shape is complementary to the fourth shape. The first and second electrode terminals may be on opposing sides of the battery, and the third and fourth electrode terminals may be on a same side of the battery. The first and second electrode terminals may establish series connections of the battery, and the third and fourth electrode terminals may establish parallel connections of the battery.

### CROSS-REFERENCE TO RELATED APPLICATION

Korean Patent Application No. 10-2013-0102120, filed on Aug. 28, 2013, and entitled, “Battery,” is incorporated by reference herein in its entirety.

### BACKGROUND

1. Field

One or more embodiments described herein relate to a battery.

2. Description of the Related Art

Generally speaking, two types of batteries are used in electronics. The first type of battery cannot be recharged and is often referred to as a primary battery. The second type of battery can be recharged and is often referred to as a secondary battery.

Batteries may also be classified in terms of their capacities. Low-capacity batteries are typically used in portable compact electronic devices, e.g., as cellular phones, notebook computers, and camcorders. Large-capacity batteries are typically used as power sources for driving motors, e.g., in hybrid vehicles. These batteries may be connected to achieve a required capacity.

In order to comply with the requirements of varying applications, it would be desirable for secondary batteries to be flexibly designed to satisfy different standards and shape restrictions. These different standards and shape restrictions are especially evident in small products such as power banks, digital cameras, and portable speakers.

An additional consideration relates to converting or preserving the use of facilities used to manufacture batteries that comply with outdated standards. For, example, as the use of compact prismatic cells decreases, the working ratio of factory production lines is lowered for these type batteries.

### SUMMARY

In accordance with one embodiment, a battery includes a plurality of first engaging portions of a first electrode; and a plurality of second engaging portions of a second electrode, wherein a (1-1)-th engaging portion of the first engaging portions has a protruding shape and wherein a (2-1)-th engaging portion of the second engaging portions has a groove shape complementary to the protruding shape.

The (1-2)-th engaging portion of the first engaging portions may have a protruding shape. A (1-3)-th engaging portion of the first engaging portions may have a groove shape complementary to the protruding shape of the (1-2)-th engaging portion. The (1-3)-th engaging portion and the (1-2)-th engaging portion may be on opposing sides of the battery. The (1-2)-th and (1-3)-th engaging portions may be adjacent to the (1-1)-th engaging portion.

A (2-2)-th engaging portion of the second engaging portions may have a groove shape at a same side of the battery at which the (1-2)-th engaging portion is located. A (2-3)-th engaging portion of the second engaging portions may have a protruding shape complementary to the groove shape of the (2-2)-th engaging portion and may be located at a same side of the battery as the (1-3)-th engaging portion. The (2-3)-th engaging portion and the (2-2)-th engaging portion may be at opposing sides of the battery. The (2-2)-th and (2-3)-th engaging portions may be adjacent to the (2-1)-th engaging portion.

The protruding shapes of the (1-1)-th, (1-2)-th, and (2-3)-th engaging portions may be of a same size, and the groove shapes of the (1-3)-th, (2-1)-th, and (2-2)-th engaging portions may be of a same size. The battery may include a prismatic cell. Also, the section of each of the first and second engaging portions may have any one of a circular shape or a quadrangular shape.

In accordance with another embodiment, a battery includes a first electrode terminal of a first shape, a second electrode terminal of a second shape, a third electrode terminal of a third shape, and a fourth electrode terminal of a fourth shape, wherein the first and third electrode terminals have a first polarity and the second and fourth electrode terminals have a second polarity opposite to the first polarity, wherein the first shape is complementary to the second shape, and wherein the third shape is complementary to the fourth shape.

The first and third shapes may be equal. The second and fourth shapes may be equal. The first and second electrode terminals may be on opposing sides of the battery, and the third and fourth electrodes may be on a same side of the battery. The first and second electrode terminals may establish series connections of the battery, and the third and fourth electrode terminals may establish parallel connections of the battery.

The battery may further include a fifth electrode terminal of the first polarity; and a sixth electrode terminal of the second polarity, wherein the third and fifth electrode terminals may be on opposing sides of the battery and wherein the fourth and sixth electrode terminals may be on opposing sides of the battery. The fifth and sixth electrode terminals may be on a same side of the battery. The fifth and sixth electrode terminals may have complementary shapes.

### BRIEF DESCRIPTION OF THE DRAWINGS

Features will become apparent to those of skill in the art by describing in detail exemplary embodiments with reference to the attached drawings in which:

FIG. 1 illustrates one embodiment of a battery;

FIG. 2A illustrates a view along section line A-A in FIG. 1, and FIG. 2B illustrates an example of an internal power connection relationship of this battery;

FIG. 3 illustrates an embodiment of batteries connected in series;

FIG. 4 illustrates an embodiment of batteries connected in parallel;

FIG. 5 illustrates an embodiment of batteries connected in series and parallel;

FIG. 6 illustrates another embodiment of a battery;

FIG. 7 illustrates a view along section line A-A in FIG. 6;

FIG. 8 illustrates another embodiment of batteries connected in series;

FIG. 9 illustrates another embodiment of batteries connected in parallel; and

FIG. 10 illustrates another embodiment of batteries in series and parallel.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

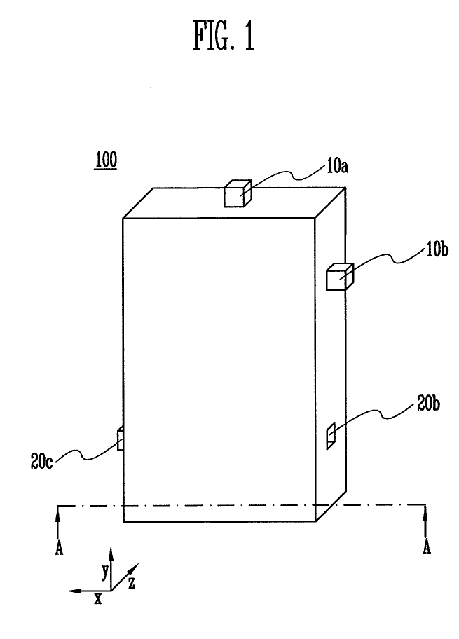

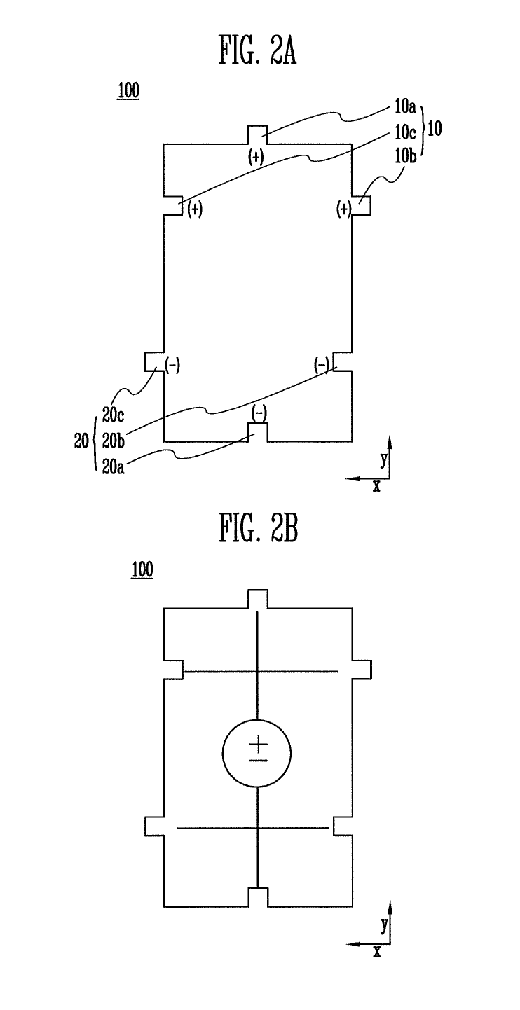

FIG. 1 illustrates an embodiment of a battery 100. FIG. 2A illustrates a view taken along section line A-A in FIG. 1. FIG. 2B illustrates an example of an internal power connection relationship of battery 100.

As shown in FIGS. 1, 2A, and 2B, battery 100 includes a plurality of first engaging portions 10a, 10b and 10c and a plurality of second engaging portions 20a, 20b, and 20c. A first electrode (e.g., a positive electrode) is formed at the plurality of first engaging portions, and a second electrode (e.g., negative electrode) is formed at the second engaging portions. That is, in this embodiment, the first engaging portions 10a, 10b and 10c may have positive polarity, and the second engaging portions 20a, 20b and 20c may have negative polarity. In other embodiments, the first engaging portions may have negative polarity and the second engaging portions may have positive polarity.

Conventional batteries have only one electrode member of a positive polarity and only one electrode member of a negative polarity. However, in the present embodiment, battery 100 has a plurality of positive-polarity electrode members and/or a plurality of negative-polarity electrode members. This arrangement may allow battery 100 to have an internal power connection relationship, for example, as illustrated in FIG. 2B.

The plurality of engaging portions 10a, 10b, 10c, 20a, 20b, and 20c may be made of a conductive material for establishing a connection to a battery and/or a load. For example, engaging portions 10a, 10b, 10c, 20a, 20b, and 20c may be made of aluminum or aluminum alloy. In other embodiments, the engaging portion may be made of one or more other metals or conductive materials.

In one embodiment, the engaging portions 10a, 10b, 10c, 20a, 20b, and 20c are formed to have protruding and/or groove shapes. These shapes may be complementary to one another, e.g., the protruding shape may be complementary to the groove shape to allow multiple batteries 100 to be physically and electrically connected to one another. The electrical connection may be a series or parallel connection, or both. For example, a (1-1)-th engaging portion 10a at a top of the battery 100 may have a protruding shape, and a (2-1)-th engaging portion 20a at a bottom of the battery 100 may have a groove shape of a size to be engaged with the protruding shape.

Also, according to one embodiment, the (1-1)-th and (2-1)-th engaging portions 10a and 20a may be used for serial connection between the batteries, corresponding to various set designs. For example, (1-2)-th and (1-3)-th engaging portions 10b and 10c may be formed at respective sides of the battery 100, while at the same time being adjacent to the (1-1)-th engaging portion 10a. That is, the (1-2)-th and (1-3)-th engaging portions 10b and 10c are formed at respective opposing sides of the battery 100.

In this embodiment, the (1-2)-th and (1-3)-th engaging portions 10b and 10c are shown to be positioned at right and left sides of the battery 100, respectively. In an alternative embodiment, the positions of the (1-2)-th and (1-3)-th engaging portions 10b and 10c may be reversed. That is, the (1-2)-th and (1-3)-th engaging portions 10b and 10c may be positioned at left and right sides of the battery 100, respectively.

In order to prevent mis-coupling between the batteries, caused by a worker, the (1-2)-th engaging portion 10b and a (2-2)-th engaging portion 20b may be positioned at the same side, and the (1-3)-th engaging portion 10c and a (2-3)-th engaging portion 20c may be positioned at the same side.

Also, the (1-2)-th engaging portion 10b may have a protruding shape at the right side of the battery 100, the (1-3)-th engaging portion 10c may have a groove shape at the left side of the battery 100 of a size to engaged the protruding shape of the (1-2)-th engaging portion 10b.

The (1-2)-th engaging portion 10b and the (1-3)-th engaging portion 10c may be used, together with the (2-2)-th engaging portion 20b and the (2-3)-th engaging portion 20c, to establish a parallel connection between two batteries, corresponding to various set designs. For example, the (1-1)-th and (1-2)-th engaging portions 10a and 20a may be used to establish a serial connection between batteries, and the (1-2)-th, (1-3)-th, (2-2)-th and (2-3)-th engaging portions 10b, 10c, 20b, and 20c may be used to establish a parallel connection between batteries. The (2-2)-th and (2-3)-th engaging portions 20b and 20c may be used to establish a parallel connection between batteries.

The (2-2)-th engaging portion 20b may have a groove shape at the right side of the battery 100, which is the same side at which the (1-2)-th engaging portion 10b is formed. The (2-3)-th engaging portion 20c may be located in opposing relation to the (2-2)-th engaging portion 20b and may have a protruding shape of a size to engage the groove shape of (2-2)-th engaging portion 20b at the left side of an adjacent battery 100. The engaging portion 20c is at the same side at which the (1-3)-th engaging portion 10c is formed.

Thus, similar to the (1-2)-th and (1-3)-th engaging portions 10b and 10c, the (2-2)-th and (2-3)-th engaging portions 20b and 20c are positioned adjacent to the (2-1)-th engaging portion 20a. In this case, the (2-2)-th and (2-3)-th engaging portions 20b and 20c are at opposing positions at respective sides of the battery 100.

As shown in FIGS. 1 and 2, the (1-2)-th and (2-2)-th engaging portions 10b and 10c at the left side of the battery 100 are respectively formed in protruding and groove shapes respectively. This structure prevents mis-coupling in a parallel connection arrangement between batteries.

That is, a parallel connection between batteries is possible may be established when (1-2)-th and (2-2)-th engaging portions 10b and 20b have protruding and groove shapes, respectively. Because (1-2)-th and (2-2)-th engaging portions 10b and 20b have different shapes, it is possible to prevent mis-coupling of batteries caused by a worker in a battery module process (e.g., to prevent a problem where one battery is turned over in a coupling between batteries in a manner that violates Kirchhoff s voltage law).

As shown in FIGS. 2A and 2B, the protruding shapes of the (1-1)-th (1-2)-th and (2-3)-th engaging portions 10a, 10b, and 20c have the same size. Also, the groove shapes of the (1-3)-th, (2-1)-th and (2-2)-th engaging portions 10c, 20a and 20b have the same size. This may be advantageous in terms of efficient manufacturing of the battery. However, in other embodiments the aforementioned engaging portions may have different sizes or shapes. For example, the protruding and groove shapes may be different from rectangular shapes.

In order to prevent mis-coupling of batteries caused, for example, by worker error, one pair of engaging portions on adjacent batteries to be coupled to each other may have shapes different from another pair of engaging portions. For example, (1-1)-th and (2-1)-th engaging portions 10a and 20a, which are coupled between batteries at respective sides of an intermediate battery, may be manufactured so that sections of (1-1)-th and (2-1)-th engaging portions 10a and 20a have a square shape. The (1-2)-th and (1-3)-th engaging portions 10b and 10c, which are coupled to additional batteries on respective sides of the intermediate battery, may be manufactured so that sections of (1-2)-th and (1-3)-th engaging portions 10b and 10c have a different (e.g., circular) shape. The (2-2)-th and (2-3)-th engaging portions 20b and 20c, which are also coupled to the aforementioned batteries, may be manufactured so that sections of the (2-2)-th and (2-3)-th engaging portions 20b and 20c have another shape or the same shape as engaging portions 10a and 20a.

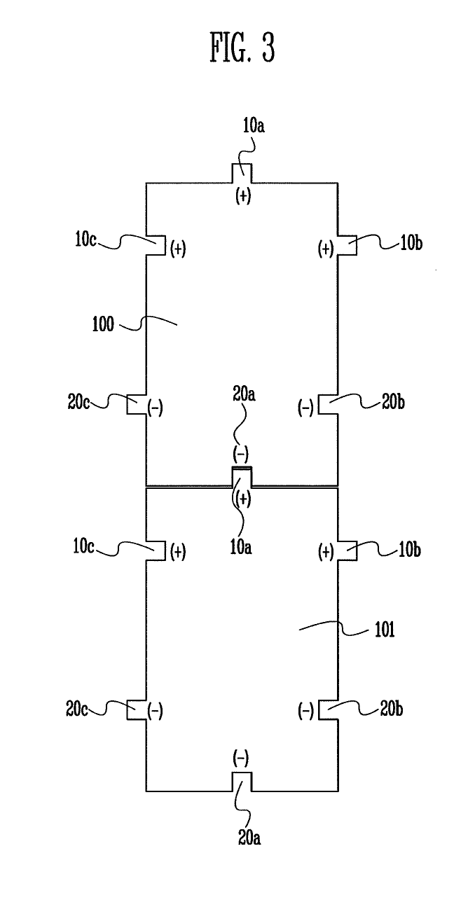

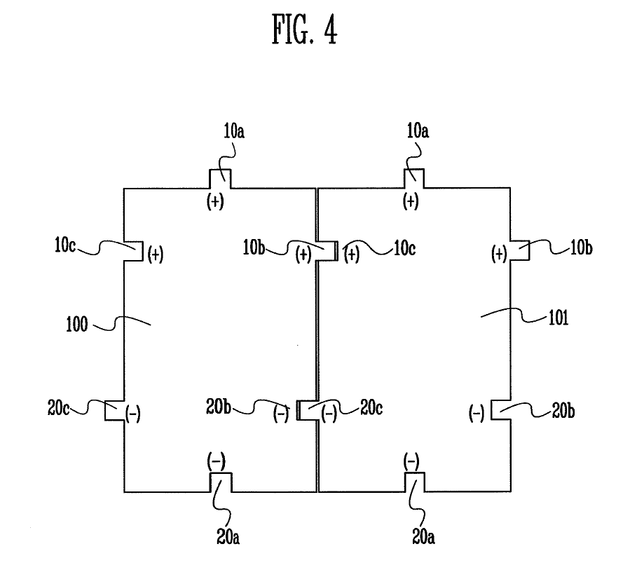

FIG. 3 illustrates an example of a series connection between batteries 100. FIG. 4 illustrates an example of a parallel connection between batteries 100. FIG. 5 illustrates an example of series and parallel connections between batteries 100. In FIGS. 3 to 5, the batteries 100 have the flexibility of complying with the same or different battery standards. That is, batteries 100 serving as basic units may be connected in series and parallel in various manners at the same or different times. Further, connection between the batteries may be established without using a separate connecting member.

Also, engaging portions of some the connected batteries may be connected to a load. Other engaging portions of these batteries may be simultaneously connected to other batteries, to thereby form an entire circuit structure.

For example, in the parallel connection of FIG. 4, (1-2)-th and (2-2)-th engaging portions 10b and 20b of a left battery 100 are respectively connected in parallel to the (1-3)-th and (2-3)-th engaging portions 10c and 20c of a right battery 101. Some other electrodes (e.g., the (1-1)-th, (1-3)-th, (2-1)-th and (2-3)-th engaging portions 10a, 10c, 20a, and 20c of the left battery 100 and (1-1)-th, (1-2)-th, (2-1)-th and (2-2)-th engaging portions 10a, 10b, 20a, and 20b of the right battery 101) are connected to a load.

In this case, the (1-3)-th and (2-3)-th engaging portions 10c and 20c of the left battery 100 may be connected to a load, to thereby form the entire circuit structure. In addition, the (1-1)-th and (2-1)-th engaging portions 10a and 20a of the left battery 100 may be connected to the same or a different load. In the same manner, the (1-2)-th and (2-2)-th engaging portions 10b and 20b of the right battery 101 or the (1-1)-th and (2-1)-th engaging portions 10a and 20a of the right battery 101 may be connected to one or more loads.

In one embodiment, battery 100 may be a prismatic cell. The engaging portions 10b, 10c, 20b, and 20c are positioned at left and right sides of battery 100. In another embodiment, engaging portions 10b, 10c, 20b, and 20c are positioned at front and rear sides of the battery 100.

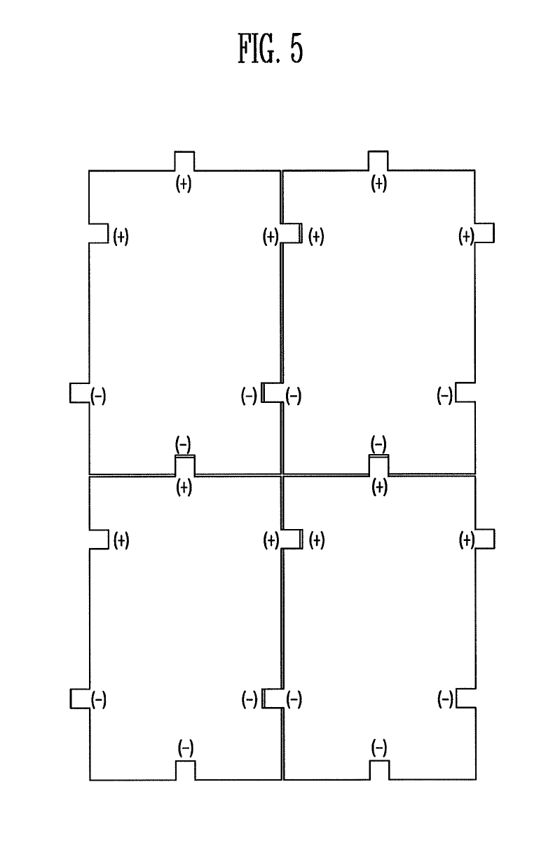

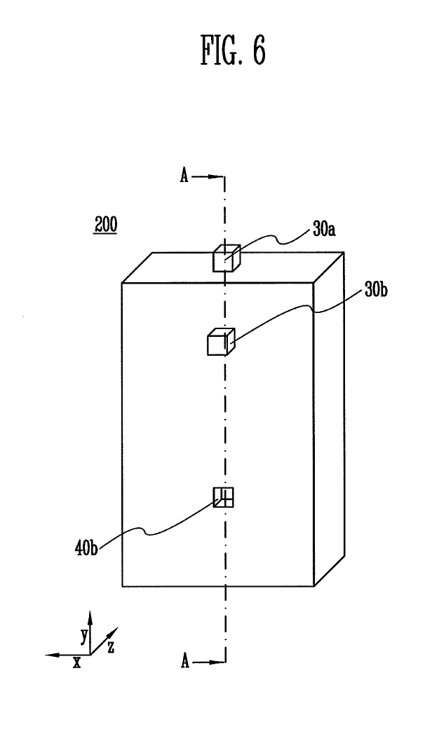

FIG. 6 illustrates another embodiment of a battery 200, and FIG. 7 illustrates a sectional view taken along line A-A of FIG. 6. As shown in FIGS. 6 and 7, engaging portions 30b, 30c, 40b and 40c may be formed at front and rear sides of a prismatic ell. Other portions may be formed in the same manner as FIGS. 1 to 5.

In this embodiment, battery 200 may be more suitable for use in a high-capacity battery module because engaging portions 30b, 30c, 40b and 40c are formed at the front and rear sides of the battery 200, which is a prismatic cell.

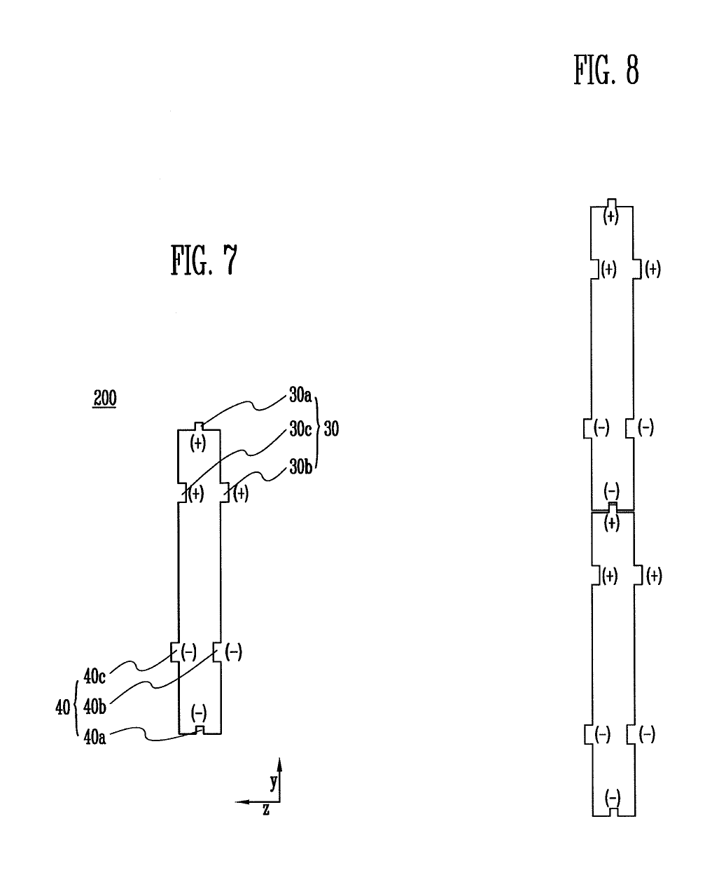

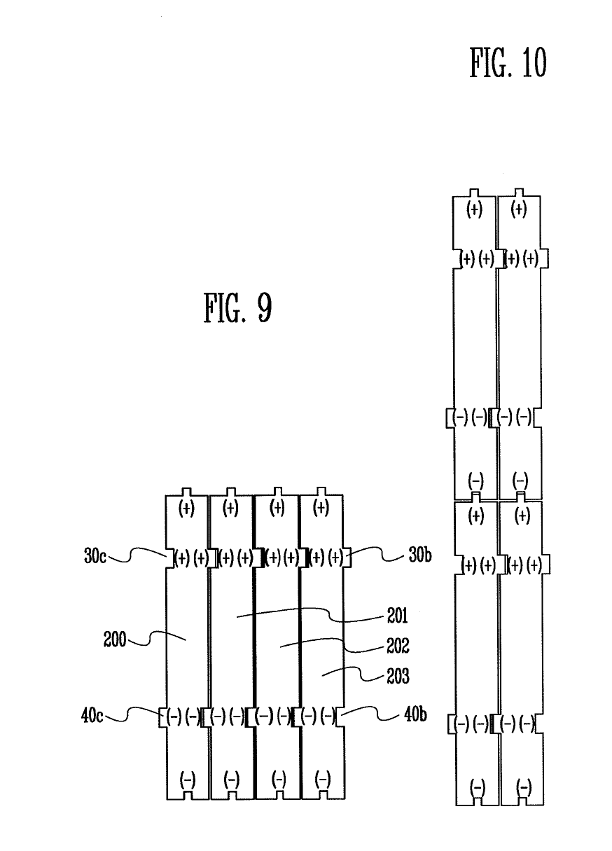

FIG. 8 illustrates a series connection of batteries 200, FIG. 9 illustrates a parallel connection of batteries 200, and FIG. 10 illustrates series and parallel connections of batteries 200. As shown in FIGS. 8 to 10, batteries 200 may be flexible to comply with a variety of battery standards. For example, as shown in FIG. 9, battery 200 may advantageously be used to form a high-capacity battery module.

Particularly, in FIG. 9, some electrodes may be connected to one or more loads. These electrodes include, for example, (1-1)-th, (1-3)-th, (2-1)-th and (2-3)-th engaging portions 30a, 30c, 40a, and 40c of a first battery 200 from the left side, (1-1)-th and (2-1)-th engaging portions 30a and 40a of a second battery 201 from the left side, (1-1)-th and (2-1)-th engaging portions 30a and 40a of a third battery 202 from the left side, and (1-1)-th, (1-2)-th, (2-1)-th and (2-2)-th engaging portions 30a, 30b, 40a, and 40b of a fourth battery 203 from the left side. Other electrodes may be used for connection between batteries 200, 201, 202, and 203.

The (1-3)-th and (2-3)-th engaging portions 30c and 40c of the first battery 200 from the left side may be connected to a load. In addition, (1-1)-th and (2-1)-th engaging portions 30a and 40a of the first battery 200 from the left side may be connected to the load. In the same manner, the (1-1)-th and (2-1)-th engaging portions 30a and 40a of the second battery 201 from the left side may be connected to the load, or the (1-1)-th and (2-1)-th engaging portions 30a and 40a of the third battery 202 from the left side or the (1-1)-th and (2-1)-th engaging portions 30a and 40a of the fourth battery 203 from the left side may be connected to the load.

In accordance with one or more of the aforementioned embodiments, a battery is provided to secure flexibility to a variety of a battery standards and connections, so that it is possible to form a battery module suitable for various set designs. Further, at least one embodiment provides a battery that may be produced using an existing compact prismatic cell production line, so that it is possible to reduce facility investment costs.

Also, in accordance with at least one embodiment, a battery is provided to be identically applied as or to a secondary battery such as a lithium ion battery or lithium polymer battery, as well as a primary battery which cannot be charged.

Also, in accordance with one or more embodiments, a battery is provided which can constitute a battery module suitable for a set design without using any separate connecting members, thereby ensuring flexibility of a battery standard for dealing with various set designs.

Also, in accordance with at least one embodiment, a battery module is provided to be suitable for various set designs without use of separate connecting members.

Also, in accordance with at least one embodiment, productivity may be increased and facility investment costs may be reduced using an existing compact prismatic cell production line to manufacture one or more of the aforementioned embodiments of the battery and/or battery modules.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery, comprising:
a plurality of first engaging portions of a first electrode; and
a plurality of second engaging portions of a second electrode, wherein a (1-1)-th engaging portion of the first engaging portions has a protruding shape and wherein a (2-1)-th engaging portion of the second engaging portions has a groove shape complementary to the protruding shape.

2. The battery as claimed in claim 1, wherein a (1-2)-th engaging portion of the first engaging portions has a protruding shape.

3. The battery as claimed in claim 2, wherein a (1-3)-th engaging portion of the first engaging portions has a groove shape complementary to the protruding shape of the (1-2)-th engaging portion.

4. The battery as claimed in claim 3, wherein the (1-3)-th engaging portion and the (1-2)-th engaging portion are formed on opposing sides of the battery.

5. The battery as claimed in claim 3, wherein the (1-2)-th and (1-3)-th engaging portions are adjacent to the (1-1)-th engaging portion.

6. The battery as claimed in claim 3, wherein a (2-2)-th engaging portion of the second engaging portions has a groove shape at a same side of the battery at which the (1-2)-th engaging portion is located.

7. The battery as claimed in claim 6, wherein a (2-3)-th engaging portion of the second engaging portions has a protruding shape complementary to the groove shape of the (2-2)-th engaging portion and is located at a same side of the battery as the (1-3)-th engaging portion.

8. The battery as claimed in claim 7, wherein the (2-3)-th engaging portion and the (2-2)-th engaging portion are at opposing sides of the battery.

9. The battery as claimed in claim 7, wherein the (2-2)-th and (2-3)-th engaging portions are adjacent to the (2-1)-th engaging portion.

10. The battery as claimed in claim 7, wherein:
the protruding shapes of the (1-1)-th, (1-2)-th, and (2-3)-th engaging portions are of a same size, and
the groove shapes of the (1-3)-th, (2-1)-th, and (2-2)-th engaging portions are of a same size.

11. The battery as claimed in claim 1, wherein the battery includes a prismatic cell.

12. The battery as claimed in claim 1, wherein the first and second engaging portions have a shape selected from the group consisting of a circular shape and a quadrangular shape.

13. A battery, comprising:
a first electrode terminal of a first shape;
a second electrode terminal of a second shape;
a third electrode terminal of a third shape; and
a fourth electrode terminal of a fourth shape,
wherein the first and third electrode terminals have a first polarity and the second and fourth electrode terminals have a second polarity opposite to the first polarity, and wherein the first shape is complementary to the second shape and the third shape is complementary to the fourth shape.

14. The battery as claimed in claim 13, wherein the first and third shapes are substantially equal.

15. The battery as claimed in claim 13, wherein the second and fourth shapes are substantially equal.

16. The battery as claimed in claim 13, wherein the first and second electrode terminals are on opposing sides of the battery, and wherein the third and fourth electrode electrodes are on a same side of the battery.

17. The battery as claimed in claim 13, wherein the first and second electrode terminals establish series connections of the battery, and wherein the third and fourth electrode terminals establish parallel connections of the battery.

18. The battery as claimed in claim 13, further comprising:
a fifth electrode terminal of the first polarity; and
a sixth electrode terminal of the second polarity,
wherein the third and fifth electrode terminals are on opposing sides of the battery and wherein the fourth and sixth electrode terminals are on opposing sides of the battery.

19. The battery as claimed in claim 18, wherein the fifth and sixth electrode terminals are on a same side of the battery.

20. The battery as claimed in claim 18, wherein the fifth and sixth electrode terminals having complementary shapes.
